(19) United States
(12) Patent Application Publication
(10) Pub. No.: US 2016/0219645 A1
(43) Pub. Date: Jul. 28, 2016

(54) CONTEXT DROP NOTIFICATION

(71) Applicant: QUALCOMM Incorporated, San Diego, CA (US)

(72) Inventors: Chintan Pravin Turakhia, San Diego, CA (US); Neelakanta Venkata Seshachalam Chimmapudi, San Diego, CA (US); Vidyadhar Adiraju, San Diego, CA (US)

(21) Appl. No.: 14/605,774

(22) Filed: Jan. 26, 2015

(51) Int. Cl. H04W 76/02; H04W 8/18

(52) U.S. Cl. CPC H04W 76/028; H04W 8/18

(57) ABSTRACT

Aspects of managing a connection in a wireless communication system are described. As an example, the aspects may include deleting, at a base station, context information associated with a radio connection of a user equipment (UE) with the base station when the base station stops serving the UE. Further, the aspects may include transmitting, by the base station, a context drop notification to one or more neighboring base stations, wherein the context drop notification indicates that the context information associated with the UE has been deleted at the base station. As such, based on associating the UE with the deleted context information, the base station or the one or more neighboring base stations may avoid attempting to fetch the context information of the UE from other neighboring base stations in response to receiving a connection re-establishment request from the UE.

### BACKGROUND

The described aspects relate generally to wireless communication systems. More particularly, the described aspects relate to techniques for a base station to keep track of and/or alert other base stations of deleted user equipment (UE) context information associated with a connection of the UE when a serving base station stops serving the UE.

Wireless communication networks are widely deployed to provide various communication services such as telephony, video, data, messaging, broadcasts, and so on.

In some instances, a user equipment (UE) may operate in communication with a base station associated with a serving cell to initiate and maintain a call with another UE. In multiple circumstances, this serving base station may stop serving the UE if one or more conditions are met. Such deterioration may occur in a variety of conditions such as, for instance, in dense urban deployments or when the UE moves from a coverage of an outdoor macro cell to an in-building small cell (e.g., a femto cell, a pico cell, a micro cell, etc.).

When the serving base station stops serving the UE and discontinues the connection with UE, the serving base station may also drop a context of the UE, e.g., delete context information associated with the connection with the UE. Delays may occur as the UE attempts to reestablish the call with one or more base stations and as those base stations then attempt to retrieve unavailable context information.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure presents examples of techniques for managing a connection in a wireless communication system. An example method may include deleting, at a base station, context information associated with a radio connection of a user equipment (UE) with the base station when the base station stops serving the UE. Further, the example method may include transmitting, by the base station, a context drop notification to one or more neighboring base stations, wherein the context drop notification indicates that the context information associated with the UE has been deleted at the base station.

Another example method may include receiving, at a first base station, a context drop notification, from a second base station, wherein the context drop notification indicates that context information associated with a radio connection of a user equipment (UE) has been deleted at the second base station. Further, the example method may include adding identification information of the UE to a deleted context database stored at the first base station.

An example apparatus for managing a connection in a wireless communication system may include means for deleting, at a base station, context information associated with a radio connection of a user equipment (UE) with the base station when the base station stops serving the UE. Further, the example apparatus may include means for transmitting, by the base station, a context drop notification to one or more neighboring base stations, wherein the context drop notification indicates that the context information associated with the UE has been deleted at the base station.

Another example apparatus for managing a connection in a wireless communication system may include a context information manager configured to delete, at a base station, context information associated with a radio connection of a user equipment (UE) with the base station when the base station stops serving the UE. Further, the example apparatus may include a notification component configured to transmit, by the base station, a context drop notification to one or more neighboring base stations, wherein the context drop notification indicates that the context information associated with the UE has been deleted at the base station.

A computer-readable medium storing computer executable code for managing a connection in a wireless communication system may include code for deleting, at a base station, context information associated with a radio connection of a user equipment (UE) with the base station when the base station stops serving the UE. Further, the computer-readable medium may include code for transmitting, by the base station, a context drop notification to one or more neighboring base stations, wherein the context drop notification indicates that the context information associated with the UE has been deleted at the base station.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram illustrating a wireless communication system in which context drop notification may implemented;

FIG. 2 is a block diagram illustrating an example of an access network having aspects for context drop notification;

FIG. 3 is a block diagram illustrating a downlink (DL) frame structure in LTE for context drop notification;

FIG. 4 is a block diagram illustrating a UL frame structure in LTE for context drop notification;

FIG. 5 is a block diagram illustrating an example of a radio protocol architecture for user and control planes for context drop notification;

FIG. 6 is a block diagram illustrating an example of an evolved Node B and user equipment in an access network having aspects for context drop notification;

FIG. 7 is a diagram illustrating one or more components by which context drop notification may be implemented;

FIG. 8 is a flow chart of aspects of a method for context drop notification;

FIG. 9 is a conceptual data flow diagram illustrating the data flow between different modules/means/components in an exemplary apparatus by which context drop notification may be implemented; and

FIG. 10 is a diagram illustrating an example of a hardware implementation for an apparatus employing a processing system by which context drop notification may be implemented.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Wireless communication networks are widely deployed to provide various communication services such as telephony, video, data, messaging, broadcasts, and so on. Such networks, which are usually multiple-access networks, support communications for multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations (e.g., eNodeBs) that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

A UE may operate in communication with a first base station associated with a serving cell to initiate and maintain a call with another communication device. In multiple circumstances, the first base station may stop serving the UE if one or more conditions are met. For example, the first base station may stop serving the UE when the quality of the connection between the UE and the first base station deteriorates below a minimum threshold level (e.g., a fast fading condition).

Further, due to the deteriorated quality of the connection, the UE may not have the information that the connection has been dropped. As such, the UE may declare a radio link failure (RLF) and attempt to reestablish the call, e.g., either with the initial serving base or with a neighboring base station. Since neither one of the initial serving base station nor the neighboring base station has the context information associated with the connection between the initial serving base station and the UE, the respective one of the initial serving base station or the neighboring base station may attempt to retrieve the context information of the UE by requesting it from other neighboring base stations (e.g., which may include the initial serving base station in the case of the request coming from the neighboring base station). Since the context information has been dropped by the initial serving base station, this attempt to retrieve the context information will fail since the context information is not stored on the other neighboring base stations. Subsequently, the respective one of the initial serving base station or the neighboring base station may then reject the request from the UE to re-establish the call and may then initiate a new connection procedure. As such, the time that it takes to reject the re-establishment request from the UE may be extended due to unnecessary communications to other neighboring base stations in an attempt to retrieve the unavailable context information.

According to the present aspects, a base station that stops serving a UE and deletes UE context information may take action to avoid unnecessary delays associated with re-establishment attempts by the UE. For example, when the first base station stops serving the UE and discontinues the connection with UE, the first base station may also drop a context of the UE. As reference herein, “context information” is data associated with a connection between the base station and UE, including but not limited to identification information of the UE and/or configuration information that defines characteristics of the connection. As also referenced herein, a “context drop”, “context dropping”, or “deleting context information” may refer to one or more operations to delete context information from a memory of the base station.

The first base station may further transmit a context drop notification to one or more neighboring base stations to indicate that the context information of the UE has been deleted at the first base station. As referenced herein, a “context drop notification” may include, but is not limited to, a message that includes UE identification information, an indicator, and/or other information that identifies that context information associated with a UE's connection to the base station has been deleted. Additionally, the first base station may also record the context drop in a database associated with the first base station for future reference, as discussed below.

In an example, if the UE requests to re-establish the call with the first base station, the first base station may check the database to determine if the context information of the UE has been deleted, e.g., before attempting to retrieve the context information from the neighboring base stations. As such, the first base station may immediately reject the re-establishment request from the UE if the check of the database indicates that the context information of the UE has been deleted. Thus, according to the present aspects, the context retrieval communications between the first base station and the neighboring base stations are not necessary in this case, and the time that it takes to reject the re-establishment request from the UE and/or initiate a new connection procedure with the UE may be expedited.

In some aspects, the neighboring base stations of the first base station may include a second base station. When the second base station receives the context drop notification from the first base station, the second base station may be configured to store the context drop notification in a database associated with the second base station.

In another example, the UE may move from a coverage area of the first base station to a coverage area of the second base station and request to re-establish the call with the second base station. When the second base station receives the re-establishment request from the UE, the second base station may check the database to determine if the context information of the UE has been deleted by the first base station, e.g., before attempting to retrieve the context information from other neighboring base stations. If the check indicates that the context information was deleted by the first base station, the second base station may reject the re-establishment request without signaling the first base station and other neighboring base station to attempt to retrieve the context information. As such, the time that it takes to reject the re-establishment request from the UE and/or initiate a new connection procedure with the UE may be similarly expedited.

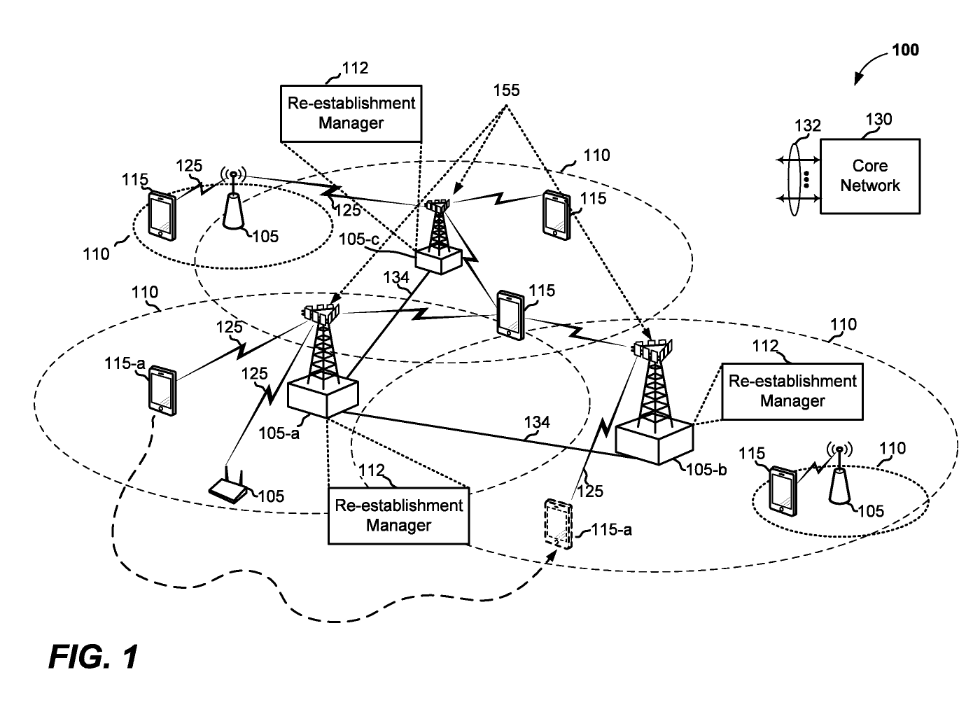

Referring first to FIG. 1, a diagram illustrates an example of wireless communication system 100, in accordance with aspect of the present disclosure. The wireless communication system 100 includes a plurality of base stations 105 (e.g., access points, eNBs, or WLAN access points), a number of user equipment (UEs) 115, and a core network 130. Base stations 105 may further include a set of neighboring base stations 155, such as a source base station 105-a serving a UE 105-a, a neighboring base station 105-b, and a neighboring base station 105-c. Source base station 105-a and each of neighboring base station 105-b and neighboring base station 105-c may include a re-establishment manager 112 that operates to avoid wasting time on attempting a re-establishment procedure with UE 115-a after source base station 105-a stops serving UE 115-a and deletes context information associated with the radio connection of UE 115-a with source base station 105-a. In particular, source base station 105-a may record the fact that it has deleted the context information of UE 105-a, and may send a context drop notification message to neighboring base station 105-b and neighboring base station 105-c to notify these neighboring base stations that the context information has been deleted. As such, if UE 105-a requests a re-establishment of the connection from any of source base station 105-a, and/or neighboring base station 105-b, and/or neighboring base station 105-c, the respective base station may check whether it has a record of the context information of UE 105-a being dropped, and if so, may avoid the context retrieval communications with neighboring base stations 155. Consequently, according to the present aspects, the time that it takes to reject the re-establishment request of UE 115-a and/or initiate a new connection procedure with UE 115-a may be expedited.

In a more comprehensive example, by operating in communication with source base station 105-a, UE 115-a may conduct a call with another communication device. Source base station 105-a may be configured to monitor the quality of the radio connection between UE 115-a and source base station 105-a that carries the call. In an aspect, source base station 105 may detect that UE 115-a is in a deteriorated radio frequency (RF) condition. Based on the quality of the radio connection, source base station 105-a may unilaterally stop serving UE 115-a if a deteriorated RF condition is met. Such deterioration may occur in one or more scenarios including dense or hyper-dense urban deployment of a corresponding network, small cell to macro cell mobility at edge of cell conditions, 6-sector deployment, or when UE 115-a moves from a macro cell to an in-building micro cell, etc. Further, source base station 105-a may also stop serving UE 115-a if a network adjustment condition is met. In at least some aspects, the deteriorated RF condition or the network adjustment condition is met upon occurrence of one or more of: retransmissions from UE 115-a have reached a maximum number determined by the configuration of the corresponding network, and/or when a block error rate (BLER) of the connection is greater than a BLER threshold, and/or when a received signal power level of UE 115-a is less than a received signal power threshold, and/or when UE 115-a has been in a dormant state for a time period that is longer than a dormancy time threshold.

When source base station 105-a stops serving UE 115-a, re-establishment manager 112 of source base station 105-a may be configured to delete context information associated with UE 115-a. The context information may include any information associated with the call and/or connection, e.g., the identification information of UE 115-a and/or configuration parameters that define characteristics of the connection. Subsequently, or prior to the deletion, re-establishment manager 112 may be further configured to transmit a context drop notification to the neighboring base stations, e.g., neighboring base station 105-b and neighboring base station 105-c. The context drop notification may indicate that the context information associated with UE 115-a has been deleted at source base station 105-a. The context drop notification may at least include the identification information of UE 115-a. Additionally, re-establishment manager 112 may add the identification information of UE 115-a to a database stored at source base station 105-a. In an aspect, the identification information may include a Cell Radio Network Temporary Identifier (C-RNTI) of UE 102, a short MAC identification (ID), and a physical cell ID (PCI) of UE 115-a. Subsequently, in this scenario, UE 115-a may determine that a radio link failure (RLF) has occurred and may attempt to re-establish the call.

In an aspect, if UE 115-a requests to re-establish the call with source base station 105-a, source base station 105-a or re-establishment manager 112 may check if the identification information of UE 115-a is included in the aforementioned database to determine whether the context information of UE 115-a has been deleted, e.g., before attempting to retrieve the context information from the other neighboring base stations 155. That is, if the aforementioned database includes the identification information of UE 115-a, re-establishment manager 112 may determine that the context information of UE 115-a has been deleted at source base station 105-a and other neighboring base stations would not have stored the context information of UE 115-a. Thus, re-establishment manager 112 may immediately reject the re-establishment request from UE 115-a. As such, the communication between source base station 105 and the other neighboring base stations 155, e.g., neighboring base station 105-b and/or neighboring base station 105-c, may not be necessary and the time that it takes to reject the re-establishment request may be expedited.

In another aspect, when the neighboring base stations, e.g., neighboring base station 105-b and/or neighboring base station 105-c, receive the context drop notification, re-establishment manager 112 of the respective neighboring base station may be configured to store the context drop notification, or the identification information included therein, in a database associated with the respective neighboring base station.

As such, in a case where UE 115-a may move from a coverage area of source base station 105-a to a coverage area of neighboring base station 105-b (as illustrated in FIG. 1 by the dashed line path of UE 115-a) and/or neighboring base station 105-c and request to re-establish the call, the respective re-establishment manager 112 may check if the identification information of UE 115-a is included in the aforementioned database. If the identification information of UE 115-a is included, then the respective re-establishment manager 112 may determine that the context information of UE 115-a has been deleted by one of neighboring base stations 155, e.g., source base station 105-a. Based on the determination that the context information of UE 115-a has been deleted, the respective neighboring base station 105-b (as illustrated in FIG. 1 by the dashed line path of UE 115-a) and/or neighboring base station 105-c may reject the re-establishment request from UE 115-a without signaling the other neighboring base stations 155. As such, the time that it takes to reject the re-establishment request from UE 115-a and/or a new connection procedure may be expedited.

In further aspects of wireless communication system 100 of FIG. 1, base stations 105 may communicate control information and/or user data with the core network 130 through backhaul links 132. In an example, neighboring base stations 155 may communicate, either directly or indirectly, with each other over backhaul links 134, which may be wired or wireless communication links. The wireless communication system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc.

The base stations 105 may wirelessly communicate with the UEs 115 via one or more access point antennas. Each of the base stations 105 may provide communication coverage for a respective coverage area 110. In some examples, base stations 105 may be referred to as a base transceiver station, a radio base station, a radio transceiver, a basic service set (BSS), an extended service set (ESS), a NodeB, eNodeB, Home NodeB, a Home eNodeB, an access point, or some other suitable terminology. The coverage area 110 for a base station may be divided into sectors making up only a portion of the coverage area (not shown). The wireless communication system 100 may include base stations 105 of different types (e.g., macro, micro, and/or pico base stations). The base stations 105 may also utilize different radio technologies, such as cellular and/or WLAN radio access technologies (RAT). The base stations 105 may be associated with the same or different access networks or operator deployments. The coverage areas of different base stations 105, including the coverage areas of the same or different types of base stations 105, utilizing the same or different radio technologies, and/or belonging to the same or different access networks, may overlap.

In LTE/LTE-A network communication systems, the terms evolved Node B (eNodeB or eNB) may be generally used to describe the base stations 105. The wireless communication system 100 may be a Heterogeneous LTE/LTE-A network in which different types of access points provide coverage for various geographical regions. For example, each of the base stations 105 may provide communication coverage for a macro cell, a pico cell, a femto cell, and/or other types of cell. Small cells such as pico cells, femto cells, and/or other types of cells may include low power nodes or LPNs. A macro cell generally covers a relatively large geographic area (e.g., several kilometers in radius) and may allow unrestricted access by UEs 115 with service subscriptions with the network provider. A small cell would generally cover a relatively smaller geographic area and may allow unrestricted access by UEs 115 with service subscriptions with the network provider, for example, and in addition to unrestricted access, may also provide restricted access by UEs 115 having an association with the small cell (e.g., UEs in a closed subscriber group (CSG), UEs for users in the home, and the like). An eNB for a macro cell may be referred to as a macro eNB. An eNB for a small cell may be referred to as a small cell eNB. An eNB may support one or multiple (e.g., two, three, four, and the like) cells.

The core network 130 may communicate with the eNBs or other base stations 105 via a backhaul link 132 (e.g., S1 interface, etc.). The base stations 105 may also communicate with one another, e.g., directly or indirectly via backhaul links 134 (e.g., X2 interface, etc.) and/or via backhaul links 132 (e.g., through core network 130). The wireless communication system 100 may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from base stations 105 may not be aligned in time. Furthermore, transmissions in the first hierarchical layer and second hierarchical layer may or may not be synchronized among base stations 105. The techniques described herein may be used for either synchronous or asynchronous operations.

The UEs 115 are dispersed throughout the wireless communication system 100, and each UE 115 may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wearable item such as a watch or glasses, a wireless local loop (WLL) station, or the like. A UE 115 may be able to communicate with macro eNodeBs, small cell eNodeBs, relays, and the like. A UE 115 may also be able to communicate over different access networks, such as cellular or other WWAN access networks, or WLAN access networks.

The communication links 125 shown in wireless communication system 100 may include uplink (UL) transmissions from a respective UE 115 to a respective base station 105, and/or downlink (DL) transmissions, from a respective base station 105 to a respective UE 115. The downlink transmissions may also be called forward link transmissions while the uplink transmissions may also be called reverse link transmissions. The UEs 115 may be configured to collaboratively communicate with multiple base stations 105 through, for example, Multiple Input Multiple Output (MIMO), carrier aggregation (CA), Coordinated Multi-Point (CoMP), or other schemes. MIMO techniques use multiple antennas on the base stations 105 and/or multiple antennas on the UEs 115 to transmit multiple data streams. Carrier aggregation may utilize two or more component carriers on a same or different serving cell for data transmission. CoMP may include techniques for coordination of transmission and reception by a number of base stations 105 to improve overall transmission quality for UEs 115 as well as increasing network and spectrum utilization.

Each of the different operating modes that may be employed by wireless communication system 100 may operate according to frequency division duplexing (FDD) or time division duplexing (TDD). In some examples, different hierarchical layers may operate according to different TDD or FDD modes. For example, a first hierarchical layer may operate according to FDD while a second hierarchical layer may operate according to TDD. In some examples, OFDMA communications signals may be used in the communication links 125 for LTE downlink transmissions for each hierarchical layer, while single carrier frequency division multiple access (SC-FDMA) communications signals may be used in the communication links 125 for LTE uplink transmissions in each hierarchical layer.

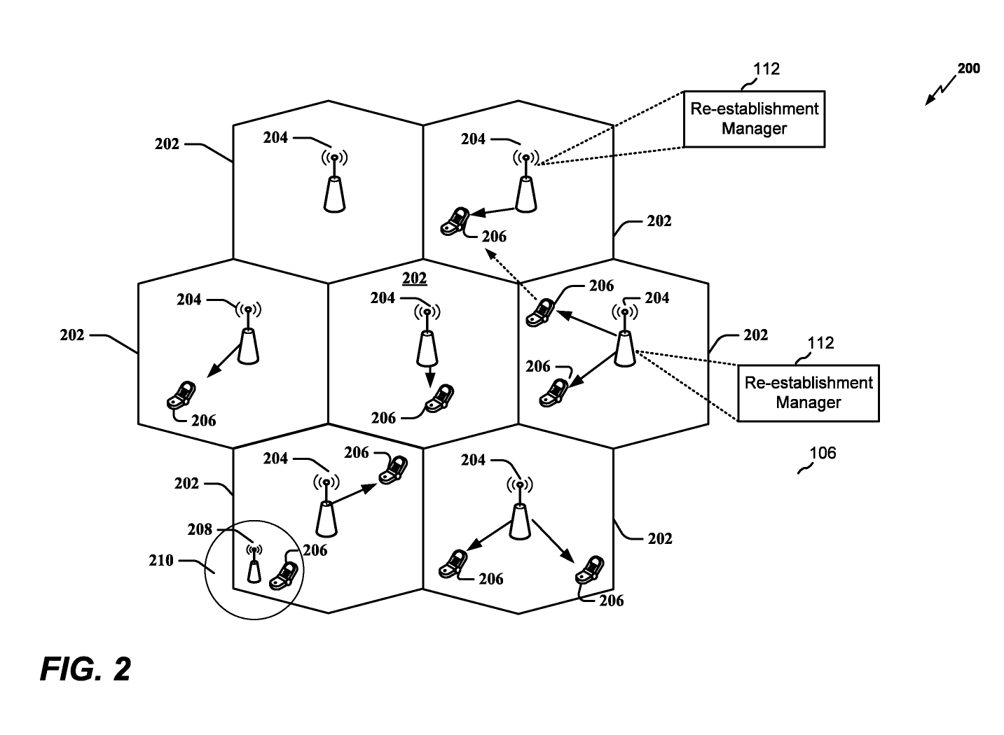

FIG. 2 is a diagram illustrating an example of an access network 200 in an LTE network architecture in which eNBs 204 and/or eNBs 208 may be an implementation of neighboring base stations 155 of FIG. 1 and may include re-establishment manager 112 configured for context drop notification and/or immediate rejection of a re-establishment request upon determining a UE is associated with a context drop notification, and where one of UEs 206 may be an implementation of UE 115-a of FIG. 1. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to a serving gateway.

The modulation and multiple access scheme employed by the access network 200 may vary depending on the particular telecommunications standard being deployed. In LTE applications, OFDM may be used on the DL and SC-FDMA may be used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

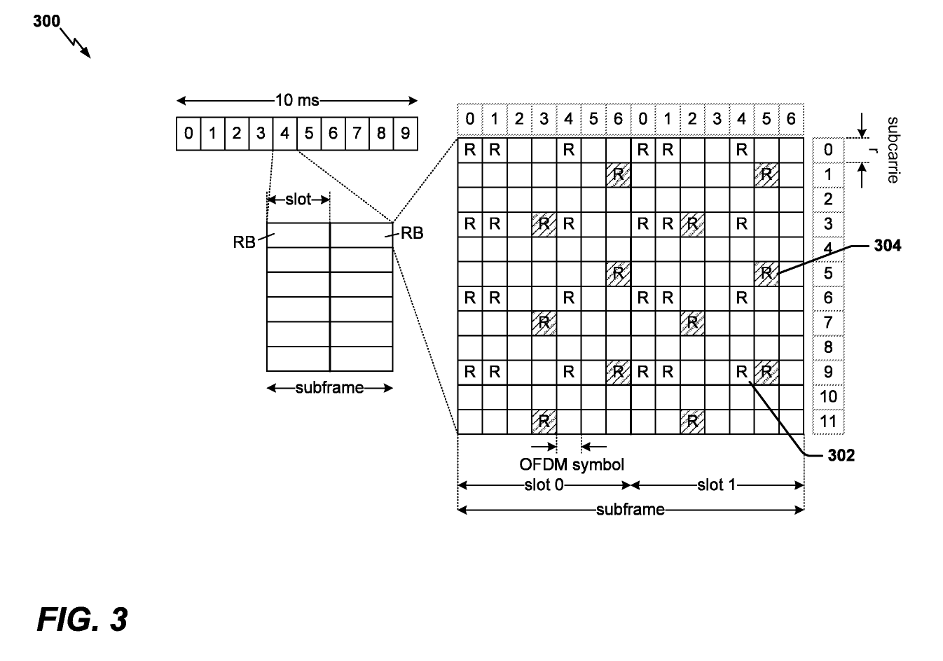

FIG. 3 is a diagram 300 illustrating an example of a DL frame structure in LTE, which may be utilized by neighboring base stations 155 (FIG. 1) and/or UE 105 (FIG. 1) described herein in conjunction with operation of re-establishment manager 112 (FIG. 1) configured for context drop notification and/or immediate rejection of a re-establishment request upon determining a UE is associated with a context drop notification as described herein. A frame (10 ms) may be divided into 10 equally sized sub-frames. Each sub-frame may include two consecutive time slots. A resource grid may be used to represent two time slots, each time slot including a resource element block. The resource grid is divided into multiple resource elements. In LTE, a resource element block may contain 12 consecutive subcarriers in the frequency domain and, for a normal cyclic prefix in each OFDM symbol, 7 consecutive OFDM symbols in the time domain, or 84 resource elements. For an extended cyclic prefix, a resource element block may contain 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource element blocks upon which the corresponding PDSCH is mapped. The number of bits carried by each resource element depends on the modulation scheme. Thus, the more resource element blocks that a UE receives and the higher the modulation scheme, the higher the data rate for the UE.

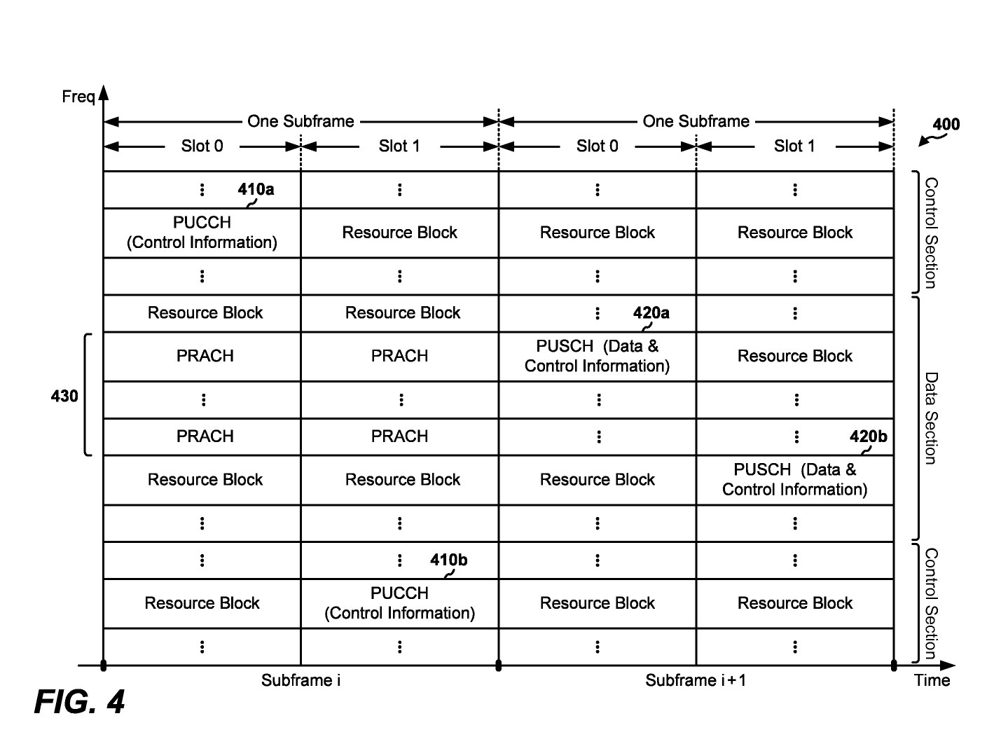

FIG. 4 is a diagram 400 illustrating an example of an UL frame structure in LTE, which may be utilized by neighboring base stations 155 (FIG. 1) and/or UE 105 (FIG. 1) described herein in conjunction with operation of re-establishment manager 112 (FIG. 1) configured for context drop notification and/or immediate rejection of a re-establishment request upon determining a UE is associated with a context drop notification as described herein. The available resource element blocks for the UL may be partitioned into a data section and a control section. The control section may be formed at the two edges of the system bandwidth and may have a configurable size. The resource element blocks in the control section may be assigned to UEs for transmission of control information. The data section may include all resource element blocks not included in the control section. The UL frame structure results in the data section including contiguous subcarriers, which may allow a single UE to be assigned all of the contiguous subcarriers in the data section.

A UE may be assigned resource element blocks 410a, 410b in the control section to transmit control information to an eNB. The UE may also be assigned resource element blocks 420a, 420b in the data section to transmit data to the eNB. The UE may transmit control information in a physical UL control channel (PUCCH) on the assigned resource element blocks in the control section. The UE may transmit only data or both data and control information in a physical UL shared channel (PUSCH) on the assigned resource element blocks in the data section. A UL transmission may span both slots of a subframe and may hop across frequency.

A set of resource element blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource element blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

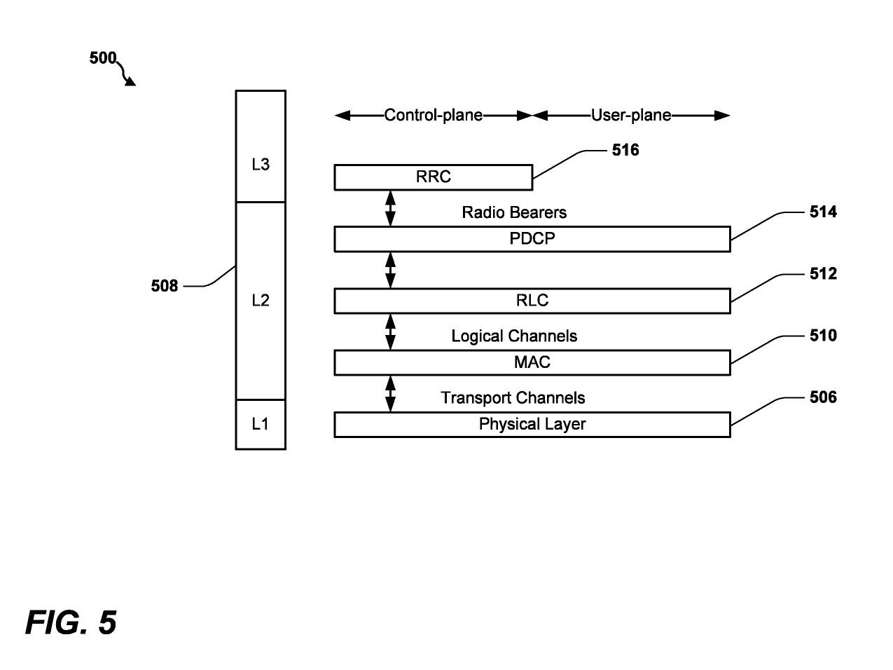

FIG. 5 is a diagram 500 illustrating an example of a radio protocol architecture for the user and control planes in LTE, which may be utilized by neighboring base stations 155 (FIG. 1) and/or UE 105 (FIG. 1) described herein in conjunction with operation of re-establishment manager 112 (FIG. 1) configured for context drop notification and/or immediate rejection of a re-establishment request upon determining a UE is associated with a context drop notification as described herein. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at a PDN gateway on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource element blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

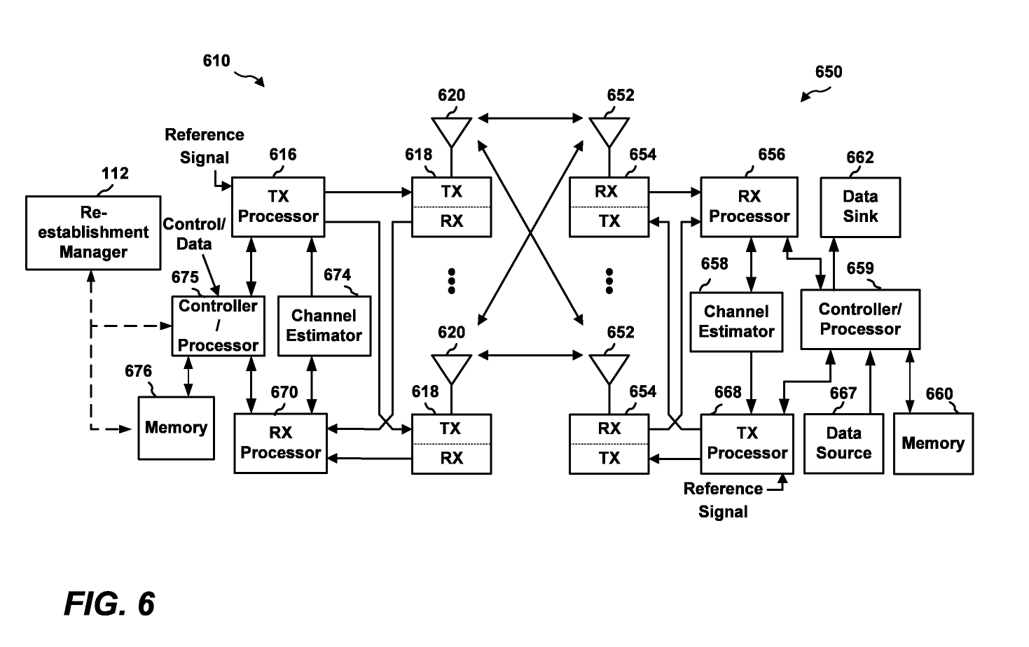

FIG. 6 is a block diagram of an eNB 610 in communication with a UE 650 in an access network, where eNB 610 may be one of neighboring base stations 155-a having a re-establishment manager 112, e.g., configured for context drop notification and/or immediate rejection of a re-establishment request upon determining a UE is associated with a context drop notification as described herein, and UE 650 may be UE 115-a as shown in FIG. 1. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission. In addition, eNB 610 may include a re-establishment manager 112 for performing the functionality described herein.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

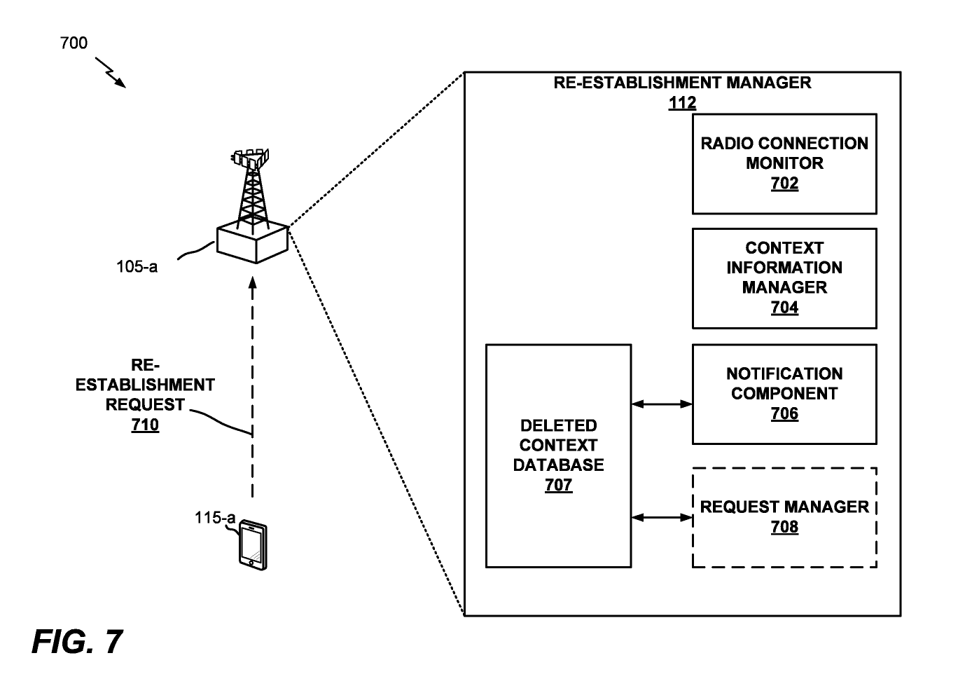

Referring to FIG. 7, diagram 700 includes one or more components of an aspect of re-establishment manager 112 (FIG. 1) configured for context drop notification and/or immediate rejection of a re-establishment request upon determining a UE is associated with a context drop notification. The term “component” or “module” as used herein may be one of the parts that make up a system, may be hardware or software, and may be divided into other components or modules. As depicted, re-establishment manager 112 of one of neighboring base stations 155, such as source base station 105-a, may include a radio connection monitor 702, a context information manager 704, a notification component 706, a deleted context database 707, and a request manager 708, each of which may be implemented as software, hardware, firmware, or any combination thereof. In at least some examples, the above components can be implemented in neighboring base stations 155, including source base station 105-a, and/or neighboring base station 105-b, and/or neighboring base station 105-c. As depicted, dash-lined blocks may indicate optional components of the aspect of re-establishment manager 112.

In an aspect, radio connection monitor 702 of re-establishment manager 112 may be configured to monitor the quality of the radio connection between UE 115-a and a respective base station, e.g., source base station 105-a, and may detect that UE 115-a is in a deteriorated radio frequency (RF). Based on the quality of the radio connection, source base station 105-a and/or components thereof may stop serving UE 115-a if a deteriorated RF condition is met or a network adjustment condition is met. Such deterioration may occur in one or more scenarios including dense or hyper-dense urban deployment of a corresponding network, small cell to macro cell mobility at edge of cell conditions, 6-sector deployment, or when UE 115-a moves from a macro cell to an in-building micro cell, etc. In at least some aspect, the deteriorated RF condition or the network adjustment condition is met upon occurrence of one or more of: retransmissions from UE 115-a having reached a maximum number determined by the configuration of the corresponding network, and/or when a block error rate (BLER) of the connection is greater than a BLER threshold, and/or when a received power level of UE 115-a is less than a received power threshold, and/or when UE 115-a has been in a dormant state for a time period that is longer than a dormancy time threshold.

When the respective base station stops serving UE 115-a, context information manager 704 of re-establishment manager 112 may be configured to delete context information associated with UE 115-a. The context information may include any information associated with the call, e.g., the identification information of UE 115-a and/or configuration parameters defining characteristics of the connection.

Subsequently, or prior to the deletion, notification component 706 may be configured to transmit a context drop notification to the other ones of neighboring base stations 155, e.g., neighboring base station 105-b, and/or neighboring base station 105-c. The context drop notification may indicate that the context information associated with UE 115-a has been deleted at source base station 105-a. Additionally, notification component 706 may add the identification information of UE 115-a to deleted context database 707 stored at the respective base station. Further, in an optional aspect, notification component 706 may be configured to start a timer when the identification information of UE 115-a is added to deleted context database 707. When the timer expires, notification component 706 may be configured to delete the identification information of UE 115-a from deleted context database 707. In an aspect, a duration to the expiration of the timer may be based on an amount of time that a UE normally takes to request a re-establishment of a call upon declaring a radio link failure. The use of this optional timer to trigger the deletion of the identification information of UE 115-a from deleted context database 707 may be used, for example, to limit the memory resources used in storing deleted context information.

In an aspect, if UE 115-a requests to re-establish the call with source base station 105-a, the re-establishment request 710 may be transmitted from UE 115-a and received by request manager 708. In an aspect, for example, re-establishment request 710 may include at least identification information of UE 115-a. Request manager 708 may check if the identification information of UE 115-a is included in deleted context database 707 to determine whether the context information of UE 115-a has been deleted, e.g., before attempting to retrieve the context information from the neighboring base stations 155. That is, if request manager 708 determines that the deleted context database 707 includes a match for the identification information of UE 115-a, then request manager 708 may determine that the context information of UE 115-a has been deleted at source base station 105-a and other neighboring base stations would not have stored the context information of UE 115-a. Thus, request manager 708 may immediately reject the re-establishment request 710 from UE 115-a. As such, the communication between source base station 105 and the other ones of neighboring base stations 155, e.g., neighboring base station 105-b, and/or neighboring base station 105-c, is not necessary and the time that it takes to reject the re-establishment request and/or to initiate a new connection may be expedited.

In another aspect, when the other ones of the neighboring base stations 155, e.g., neighboring base station 105-b, and/or neighboring base station 105-c, receive the context drop notification, a respective notification component 706 on these base stations may be configured to store the identification information in a respective deleted context database 707 associated with the respective neighboring base stations.

In an example, UE 115-a may move from a coverage area of source base station 105-a to a coverage area of neighboring base station 105-b (see, e.g., FIG. 1) and may request to re-establish the call with neighboring base station 105-b. Similarly, request manager 708 of re-establishment manager 112 of neighboring base station 105-b may check if the identification information of UE 115-a is included in deleted context database 707 associated with target base station 105. If the identification information of UE 115-a is included, request manager 708 of re-establishment manager 114 may determine that the context information of UE 115-a has been deleted by one of the other neighboring base stations 155 or by neighboring base station 105-b itself. Based on the determination that the context information of UE 115-a has been deleted, neighboring base station 105-b may reject the re-establishment request from UE 115-a without signaling other ones of the neighboring base stations 155, e.g., source base station 105-a and/or neighboring base station 105-c. As such, the time that it takes to reject the re-establishment request from UE 115-a and/or initiate a new connection procedure may be expedited.

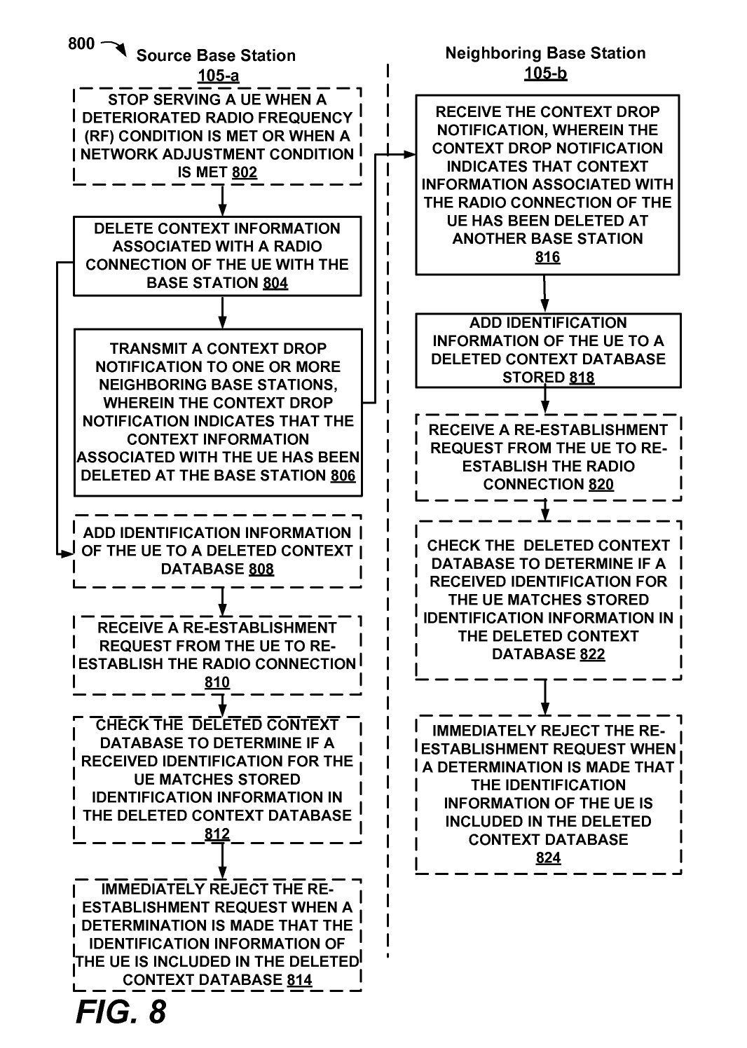

Referring to FIG. 8, an aspect of a method 800 for context drop notification may be performed by one or more of neighboring base stations 155, such as source base station 105-a and neighboring base station 105-b of FIG. 1 and the components thereof, as detailed in FIG. 7. More specifically, aspects of method 800 may be performed by one or more of radio connection monitor 702, context information manager 704, notification component 706, deleted context database 707, and request manager 708, as shown in FIG. 7, of source base station 105-a and/or neighboring base station 105-b. As illustrated in FIG. 8, dash-lined blocks may indicate optional operations of method 800.

At 802, method 800 includes stopping serving a UE, at a source base station, when a deteriorated RF condition is met or when a network adjustment condition is met. That is, radio connection monitor 702 of re-establishment manager 112 may be configured to monitor the quality of the radio connection between UE 115-a and a respective base station, e.g., source base station 105-a, and may detect that UE 115-a is in a deteriorated radio frequency (RF). Based on the quality of the radio connection, source base station 105-a and/or components thereof may stop serving UE 115-a if a deteriorated RF condition is met or a network adjustment condition is met. Such deterioration may occur in one or more scenarios including dense or hyper-dense urban deployment of a corresponding network, small cell to macro cell mobility at edge of cell conditions, 6-sector deployment, or when UE 115-a moves from a macro cell to an in-building micro cell, etc. In at least some aspect, the deteriorated RF condition or the network adjustment condition is met upon occurrence of one or more of: retransmissions from UE 115-a have reached a max number determined by the configuration of the corresponding network, and/or when a block error rate (BLER) of the connection is greater than a BLER threshold, and/or when a received power level of UE 115-a is less than a received power threshold, and/or when UE 115-a has been in a dormant state for a time period that is longer than a dormancy time threshold.

At 804, method 800 includes deleting, at a source base station, context information associated with a radio connection of a UE with the base station when the base station stops serving the UE. That is, when the respective base station stops serving UE 115-a, context information manager 704 of re-establishment manager 112 may be configured to delete context information associated with UE 115-a. The context information may include any information associated with the call, e.g., the identification information of UE 115-a.

At 806, method 800 includes transmitting, by the source base station, a context drop notification to one or more neighboring base stations, wherein the context drop notification indicates that the context information associated with the UE has been deleted at the base station. That is, subsequently, or prior to the deletion, notification component 706 may be configured to transmit a context drop notification to other ones of the neighboring base stations 155, e.g., from source base station 105-a to neighboring base station 105-b and/or neighboring base station 105-c. The context drop notification may indicate that the context information associated with UE 115-a has been deleted at source base station 105-a. In at least some examples, the context drop notification may be transmitted via an X2 interface in Long Term Evolution (LTE).

At 808, method 800 includes adding identification information of the UE to a deleted context database stored at the base station. That is, in addition to transmitting the context drop notification to the neighboring base stations, notification component 706 may add the identification information of UE 115-a to deleted context database 707 stored at the respective base station, e.g., source base station 105-a. In at least some optional aspects, notification component 706 may be additionally configured to start a timer when the identification information of UE 115-a is added to deleted context database 707. When the timer expires, notification component 706 may be configured to delete the identification information of UE 115-a from deleted context database 707.

At 810, method 800 includes receiving a re-establishment request from the UE to re-establish the radio connection subsequent to the deleting. That is, request manager 708 may receive the re-establishment request transmitted from UE 115-a when UE 115-a requests to re-establish the call with the respective base station, e.g., source base station 105-a. The re-establishment request may include the identification of UE 115-a.

At 812, method 800 includes checking, in response to the receiving of the re-establishment request, a deleted context database to determine if a received identification for the UE matches stored identification information in the deleted context database. That is, request manager 708 may check if the identification information of UE 115-a is included in deleted context database 707 to determine whether the context information of UE 115-a has been deleted, before attempting to retrieve the context information from any of the other ones of neighboring base stations 155.

At 814, method 800 includes rejecting the re-establishment request when a determination is made that the identification information of the UE is included in the deleted context database. That is, if the deleted context database 707 includes the identification information of UE 115-a, request manager 708 may determine that the context information of UE 115-a has been deleted at source base station 105-a and other neighboring base stations would not have stored the context information of UE 115-a. Thus, request manager 708 may immediately reject the re-establishment request from UE 115-a. As such, the communication between source base station 105 and the neighboring base stations may not be necessary and the time that it takes to reject the re-establishment request may be expedited. Alternatively, in some examples, if the deleted context database 707 does not include the identification information of UE 115-a, request manager 708 may be configured to request the context information from one or more neighboring base stations.

At 816, method 800 includes receiving, at a first base station (e.g., neighboring base station), a context drop notification, from a second base station (e.g., source base station), wherein the context drop notification indicates that context information associated with a radio connection of a UE has been deleted at the second base station. That is, notification component 706 of neighboring base station 105-b may be configured to receive the context drop notification from source base station 105-a, wherein the context drop notification indicates that the context information associated with a radio connection of UE 115-a has been deleted at source base station 105-a.

At 818, method 800 includes adding identification information of the UE to a deleted context database stored at the first base station. That is, notification component 706 of neighboring base station 105-b may be configured to store the identification information of UE 115-a in deleted context database 707 associated with neighboring base station 105-b.

At 820, method 800 includes receiving a re-establishment request from the UE to re-establish the radio connection (e.g., a call). That is, in some examples, UE 115-a may move from a coverage area of source base station 105-a to a coverage area of neighboring base station 105-b and may request to re-establish the call with neighboring base station 105-b. Request manager 708 of re-establishment manager 114 of neighboring base station 105-b may receive the re-establishment request from UE 115-a. The re-establishment request may also include identification of UE 115-a.

At 822, method 800 includes checking, in response to the receiving of the re-establishment request, a deleted context database to determine if a received identification for the UE matches stored identification information in the deleted context database. That is, request manager 708 of re-establishment manager 114 of neighboring base station 105-b may check if the identification information of UE 115-a is included in deleted context database 707 associated with neighboring base station 105-b. If the identification information of UE 115-a is included, request manager 708 of re-establishment manager 114 may determine that the context information of UE 115-a has been deleted by another one of the neighboring base stations 155 or by neighboring base station 105-b itself.

At 824, method 800 includes rejecting the re-establishment request when a determination is made that the identification information of the UE is included in the deleted context database. That is, based on the determination that the context information of UE 115-a has been deleted, neighboring base station 105-b may immediately reject the re-establishment request from UE 115-a without signaling source base station 105-a and other neighboring base stations. As such, the time that it takes to reject the re-establishment request from UE 115-a may be similarly expedited. In some examples, if a determination is made that the context information of UE 115-a has not been deleted, neighboring base station 105-b may be configured to request the context information of UE 115-a from source base station 105-a and other neighboring base stations.

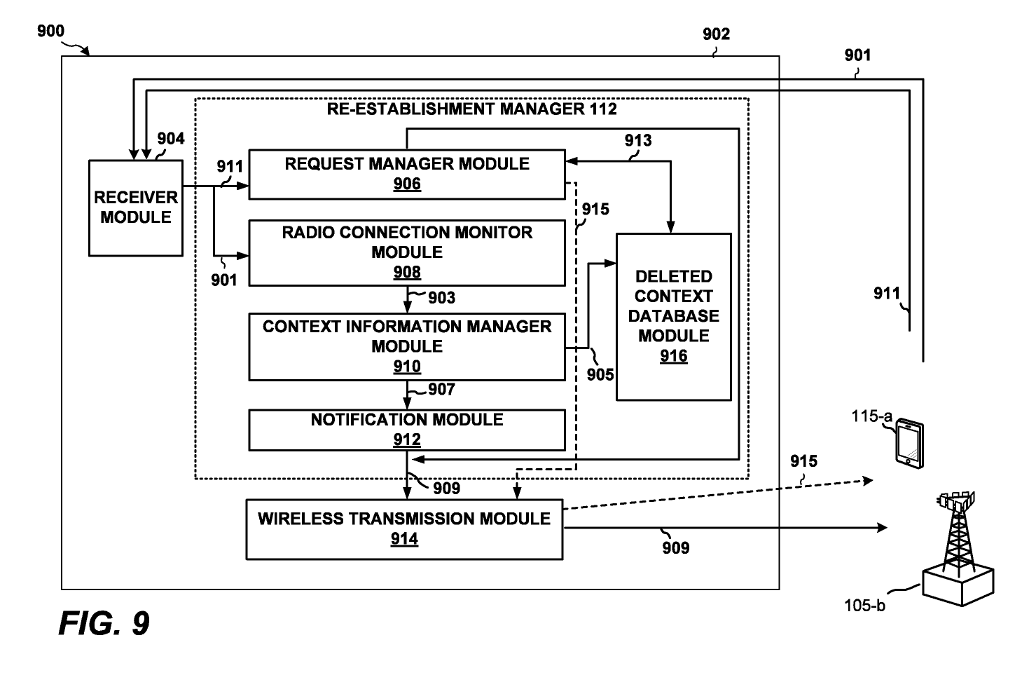

FIG. 9 is a conceptual data flow diagram 900 illustrating the data flow between different components in an exemplary apparatus 902, where apparatus 902 may be a base station such as one of neighboring base stations 155, e.g., source base station 105-a or neighboring base station 105-b or neighboring base station 105-c, including re-establishment manager 112. In the aspect of apparatus 902, the components of re-establishment manager 112 may be implemented as one or more hardware modules, or one or more software modules, or some combination thereof. For example, radio connection monitor 702 (FIG. 7), context information manager 704, notification component 706, request manager 708, and deleted context database 707 may respectively be implemented as radio connection monitor module 908, context information manager module 910, notification module 912, request manager module 906, and deleted context database module 916. Although not illustrated, each of the modules of apparatus 902 may be communicatively coupled, such as with a bus or other interface between the modules. In operation, the apparatus 902 includes a receiver module 904 that receives re-establishment requests from UE 115-a, a request manager module 906 that checks if the identification information of UE 115-a is included in deleted context database module 916, a radio connection monitor module 908 that monitors the quality of the radio connection between apparatus 902 and UE 115-a, a context information manager module 910 that deletes context information associated with UE 115-a when a deteriorated RF condition or a network adjustment condition is met or any other condition exists where apparatus 902 stops serving UE 115-a, and adds the identification information of UE 115-a to deleted context database module 916, a notification module 912 that transmits a context drop notification to neighboring base stations, and a wireless transmission module 914 that transmits wireless signals to UE 115-a and/or other neighboring base stations 155, such as neighboring base station 105-b. In an aspect, wireless transmission module 914 transmits a context drop notification to other neighboring base stations 155, such as neighboring base station 105-b, as described herein.

In an aspect, based on monitoring the radio connection 901 between apparatus 902 and UE 115-a, radio connection monitor module 908 may determine a deteriorated RF condition or a network adjustment condition is met. As a result, apparatus 902 may stop serving UE 115-a, radio connection monitor module 908 may send a notification 903 to context information manager module 910, context information manager module 910 may delete the context information associated with UE 115-a from a memory, and may send a command 905 to add the identification information of UE 115-a to deleted context database module 916. Further, context information manager module 910 may send a message 907 indicating the deletion of the UE context information to notification module 912, and notification module 912 may generate a context drop notification 909, e.g., including at least identification information of UE 105-a. Further, notification module 912 may send context drop notification 909 to wireless transmission module 914, which transmits context drop notification 909 to neighboring base stations 155, such as neighboring base station 105-b.

When receiver module 904 and/or request manager module 906 receives a re-establishment request 911 (which may be the same as re-establishment request 710 of FIG. 7) from UE 115-a, request manager module 906 may exchange communications 913 with deleted context database module 916 to check if the identification information of UE 115-a is included in deleted context database module 916. If the identification information of UE 115-a is included in deleted context database module 916, request manager module 906 may generate a rejection message 915 to reject the re-establishment request, and forward rejection message 915 to wireless transmission module 914 for transmission to UE 105-a. Thus, apparatus 902 may reject re-establishment request 911 without attempting to retrieve the context information from the neighboring base stations 155.

The apparatus 902 may include additional modules that perform each of the steps of the re-establishment manager algorithm described in the aforementioned flow chart of FIG. 8 or as otherwise described herein. As such, each step in the aforementioned flow chart of FIG. 8 may be performed by a module and the apparatus may include one or more of those modules. The modules may be one or more hardware components specifically configured to carry out the stated processes/algorithm, implemented by a processor configured to perform the stated processes/algorithm, computer-executable code stored within a computer-readable medium for implementation by a processor, or some combination thereof.

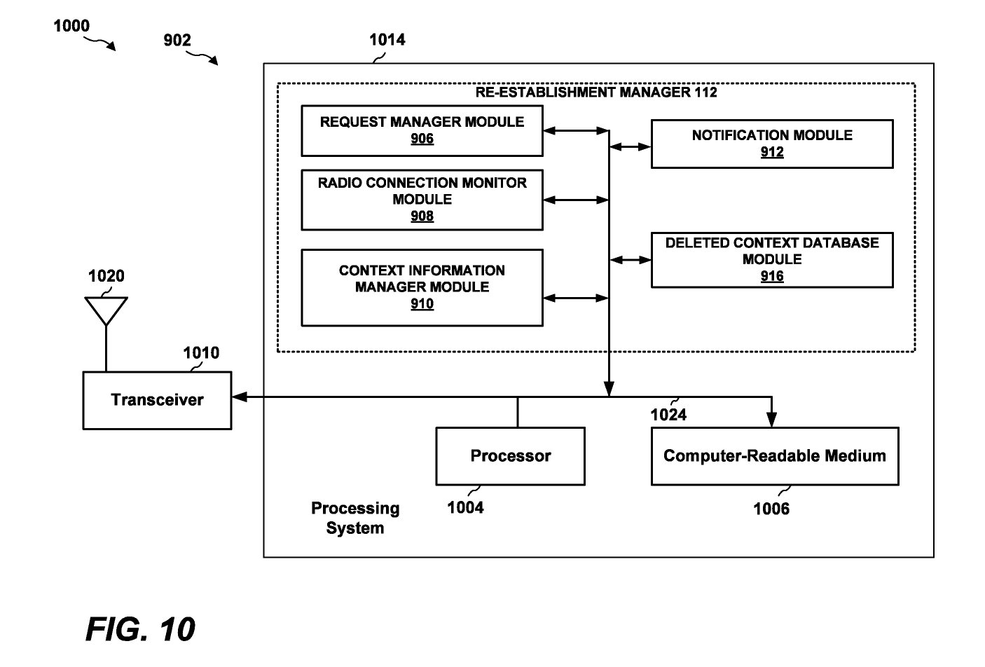

FIG. 10 is a diagram illustrating an example of a hardware implementation for an apparatus 1000 employing a processing system 1014, where apparatus 1000 may implement apparatus 902 (FIG. 9), and hence re-establishment manager 112 as described herein, within processing system 1014. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware modules that may be configured to implement re-establishment manager 112, represented by the processor 1004, request manager module 906, radio connection monitor module 908, context information manager module 910, notification module 912, deleted context database module 916, and/or the computer-readable medium 1006. The bus 1024 may also link various other circuits such as timing sources, peripherals, voltage regulators, and power management circuits, which are well known in the art, and therefore, will not be described any further.

The processing system 1014 may be coupled to a transceiver 1010. The transceiver 1010 is coupled to one or more antennas 1020. The transceiver 1010 provides a means for communicating with various other apparatus over a transmission medium. In addition, the transceiver 1010 may be configured to receive resource grants for transmitting a ULL frame structure and/or user data for transmission to one or more eNBs. The processing system 1014 includes a processor 1004 coupled to a computer-readable medium 1006. The processor 1004 is responsible for general processing, including the execution of software stored on the computer-readable medium 1006. The software, when executed by the processor 1004, causes the processing system 1014 to perform the various functions described supra for any particular apparatus. The computer-readable medium 1006 may also be used for storing data that is manipulated by the processor 1004 when executing software. As noted above, the processing system 1014 can further include and execute at least one of request manager module 906, radio connection monitor module 908, context information manager module 910, notification module 912, deleted context database module 916 to implement the functionality of re-establishment manager 112 as described herein. In an aspect, these modules may be software modules stored in the computer-readable medium 1006 and executed by the processor 1004, and/or one or more hardware modules that are a part of or that are coupled to the processor 1004, or some combination thereof. The processing system 1014 may thus be a component of the base stations and/or eNBs described herein.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

1. A method for managing a connection in a wireless communication system, comprising:
stopping serving a user equipment (UE) at a base station;
deleting, at the base station, context information associated with a radio connection of the UE with the base station; and
transmitting, by the base station, a context drop notification to one or more neighboring base stations, wherein the context drop notification indicates that the context information associated with the UE has been deleted at the base station.

2. The method of claim 1, further comprising:
subsequent to the deleting, receiving a re-establishment request from the UE to re-establish the radio connection;
checking, in response to the receiving of the re-establishment request, a deleted context database to determine if a received identification for the UE matches stored identification information in the deleted context database; and
rejecting the re-establishment request when a determination is made that the identification information of the UE is included in the deleted context database.

3. The method of claim 1, further comprising adding identification information of the UE to a deleted context database stored at the base station.

4. The method of claim 2, further comprising:
starting a timer for the identification information of the UE when the identification information is added; and
deleting the identification information of the UE from the deleted context database when the timer expires.

5. The method of claim 1, wherein the stopping serving the UE comprises stopping serving the UE when a deteriorated radio frequency (RF) condition is met or when a network adjustment condition is met.

6. The method of claim 5, wherein the deteriorated RF condition is met upon occurrence of one or more of:
a maximum number of retransmissions is met; and/or
a block error rate (BLER) is greater than a BLER threshold; and/or
a received signal power level is less than a received signal power threshold; and/or
the UE has been in a dormant state for a time period that is longer than a dormancy time threshold.

7. The method of 5, wherein the network adjustment condition is met upon occurrence of one or more of:
a maximum number of retransmissions is met; and/or
a block error rate (BLER) is greater than a BLER threshold; and/or
a received signal power level is less than a received signal power threshold; and/or
the UE has been in a dormant state for a time period that is longer than a dormancy time threshold.

8. The method of claim 1, wherein the transmitting comprises transmitting the context drop notification via an X2 interface in Long Term Evolution (LTE).

9. The method of claim 3, wherein the identification information of the UE includes a Cell Radio Network Temporary Identifier (C-RNTI) of the UE, a short MAC identification (ID), and a physical cell ID (PCI) of the UE.

10. A method for managing a connection in a wireless communication system, comprising:
receiving, at a first base station, a context drop notification, from a second base station, wherein the context drop notification indicates that context information associated with a radio connection of a user equipment (UE) has been deleted at the second base station; and
adding identification information of the UE to a deleted context database stored at the first base station.

11. The method of claim 10, further comprising:
receiving a re-establishment request from the UE to re-establish the radio connection;
checking, in response to the receiving of the re-establishment request, the deleted context database to determine if a received identification for the UE matches stored identification information in the deleted context database; and
rejecting the re-establishment request when a determination is made that the identification information of the UE is included in the deleted context database.

12. The method of claim 10, further comprising:
starting a timer for the identification information of the UE when the identification information is added; and
deleting the identification information of the UE from the deleted context database when the timer expires.

13. The method of claim 10, wherein the receiving comprises receiving the context drop notification via an X2 interface in Long Term Evolution (LTE).

14. An apparatus for managing a connection in a wireless communication system, comprising:
a memory configured to store instructions; and
at least one processor coupled to the memory, the at least one processor and the memory are configured to execute the instructions to:
delete, at a base station, context information associated with a radio connection of a user equipment (UE) with the base station when the base station stops serving the UE; and
transmit, by the base station, a context drop notification to one or more neighboring base stations, wherein the context drop notification indicates that the context information associated with the UE has been deleted at the base station.

15. The apparatus of claim 14, wherein the at least one processor and the memory are further configured to execute the instructions to:
receive a re-establishment request from the UE to re-establish the radio connection subsequent to the deleting;
check, in response to the receiving of the re-establishment request, a deleted context database to determine if a received identification for the UE matches stored identification information in the deleted context database; and
reject the re-establishment request when a determination is made that the identification information of the UE is included in the deleted context database.

16. The apparatus of claim 14, wherein the at least one processor and the memory are further configured to execute the instructions to add identification information of the UE to a deleted context database stored at the base station.

17. The apparatus of claim 16, wherein the at least one processor and the memory are further configured to execute the instructions to:
start a timer for the identification information of the UE when the identification information is added; and
delete the identification information of the UE from the deleted context database when the timer expires.

18. The apparatus of claim 14, wherein the base station stops serving the UE when a deteriorated radio frequency (RF) condition is met or when a network adjustment condition is met.

19. The apparatus of claim 18, wherein the deteriorated RF condition is met upon occurrence of one or more of:
a maximum number of retransmissions is met; and/or
a block error rate (BLER) is greater than a BLER threshold; and/or
a received signal power level is less than a received signal power threshold; and/or
the UE has been in a dormant state for a time period that is longer than a dormancy time threshold.

20. The apparatus of claim 18, wherein the network adjustment condition is met upon occurrence of one or more of:
a maximum number of retransmissions is met; and/or
a block error rate (BLER) is greater than a BLER threshold; and/or
a received signal power level is less than a received signal power threshold; and/or
the UE has been in a dormant state for a time period that is longer than a dormancy time threshold.
